(19) United States
(12) Patent Application Publication
(10) Pub. No.: US 2010/0273027 A1
(43) Pub. Date: Oct. 28, 2010

(54) Magnetic printing stamp, method of manufacturing magnetic printing stamp and magnetic printing method

(75) Inventors: Myung-bok Lee, Suwon-si (KR); Kyoung-won Na, Seoul (KR); Sang-chul Sul, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/662,412

(22) Filed: Apr. 15, 2010

(30) Foreign Application Priority Data
Apr. 23, 2009 (KR) 10-2009-0035526

(51) Int. Cl. G11B 5/33

(52) U.S. Cl. 428/800; 216/22

(57) ABSTRACT

A magnetic printing stamp and a magnetic printing method using the same. The magnetic printing stamp may includes a plurality of servo regions having a magnetic body pattern and a plurality of data regions having no magnetic body pattern that are alternately formed, wherein a thickness of a portion of a substrate corresponding to each of the servo regions is less than a thickness of a portion of the substrate corresponding to each of the data regions. When a servo pattern is to be magnetically printed, the magnetic printing stamp and a magnetic recording medium uniformly and completely come in contact with each other. Thus, the magnetic printing stamp and the magnetic recording medium are prevented from being contaminated or damaged. In addition, excellent magnetic printing properties corresponding to an uneven pattern may be achieved.

### CROSS-REFERENCE TO RELATED APPLICATIONS

This application claims priority under 35 U.S.C. §119 to Korean Patent Application No. 10-2009-0035526, filed on Apr. 23, 2009, in the Korean Intellectual Property Office (KIPO), the disclosure of which is incorporated herein in its entirety by reference.

### BACKGROUND

1. Field

Example embodiments relate to a method and apparatus for recording information, and more particularly, to a magnetic printing stamp, a method of manufacturing the magnetic printing stamp, and a magnetic printing method.

2. Description of the Related Art

Due to the development of hard disc drive (HDD) technology, there is a need for high-capacity and high-speed HDDs. In order to achieve high-capacity HDDs, large amounts of information need to be recorded on a predetermined area of a disc. In order to drive a HDD that uses a magnetic recording medium, servo information needs to be previously recorded in order to position a magnetic head on a desired position of the magnetic recording medium. The servo information is recorded in a servo pattern that is formed by magnetizing a recording layer of the magnetic recording medium in a predetermined pattern. Thus, recently, active research has been conducted on a magnetic printing method in which a magnetic printing stamp having a pattern corresponding to a servo pattern comes in contact with a magnetic recording medium, and simultaneously, the servo pattern is magnetically-printed by applying an external magnetic field to the magnetic recording medium.

### SUMMARY

Example embodiments provide a magnetic printing stamp and a method of manufacturing the magnetic printing stamp by which a servo pattern is effectively magnetically-printed on a magnetic recording medium, and a magnetic printing method using the magnetic printing stamp.

According to an example embodiment, there is provided an example of a magnetic printing stamp including a plurality of servo regions having a magnetic body pattern, and a plurality of data regions having no magnetic body pattern, wherein the plurality of servo regions and the plurality of data regions are alternately formed, and wherein a thickness of a portion of a substrate corresponding to each of the servo regions is less than a thickness of a portion of the substrate corresponding to each of the data regions.

A material for forming the portion of the substrate corresponding to each of the servo regions may be the same as or more flexible than a material for forming the portion of the substrate corresponding to each of the data regions.

An uneven structure corresponding to a servo pattern may be formed in the portion of the substrate corresponding to each of the servo regions, and a magnetic body may be embedded in grooves of the uneven structure.

Each of the servo regions may include a first polymer layer formed as the lowest layer of each of the servo regions, a seed metal layer formed on the first polymer layer, and a second polymer layer having an uneven structure formed on the seed metal layer, a magnetic body may be embedded in grooves of the uneven structure of the second polymer.

Each of the servo regions may include a silicon (Si) substrate formed as the lowest layer of each of the servo regions, and a polymer layer having an uneven structure formed on the Si substrate, wherein a magnetic body film may be coated on a surface of the polymer layer.

The magnetic body may include CoFe or CoNiFe, wherein the magnetic body may have a high saturation magnetic flux density equal to or greater than 1.5 T, and the magnetic body may have a coercive force equal to or less than 100 Oe.

According to another example embodiment, there is provided a method of manufacturing a magnetic printing stamp. The example method may include coating an electron beam resist on a substrate of the magnetic printing stamp, patterning a servo pattern onto the electron beam resist, etching a portion of the substrate of the magnetic printing stamp in a servo region to have a shape corresponding to a servo pattern of the electron beam resist, removing the electron beam resist, coating a magnetic body film on the portion of the substrate of the magnetic printing stamp in the servo region, and then forming a magnetic body corresponding to the servo pattern, and etching a lower portion of the portion of the substrate of the magnetic printing stamp in the servo region.

According to another example embodiment, there is provided another example method of manufacturing a magnetic printing stamp. This example method may include coating a first polymer layer on a substrate of the magnetic printing stamp to a predetermined or desired thickness, depositing seed metal on the first polymer layer, coating a second polymer layer on the seed metal, covering the second polymer layer with a transparent stamp having an uneven structure corresponding to a servo pattern, radiating ultraviolet (UV) light, and magnetically printing the servo pattern onto the second polymer layer. The method may also include removing the seed metal except for a portion corresponding to a portion of the substrate of the magnetic printing stamp in a servo region, forming a magnetic body corresponding to the servo pattern on the seed metal, and etching a lower portion of the portion of the substrate of the magnetic printing stamp in the servo region.

According to another example embodiment, there is provided another example method of manufacturing a magnetic printing stamp. This example method may include coating a polymer layer on a substrate of the magnetic printing stamp, covering the polymer layer with a transparent stamp having an uneven structure corresponding to a servo pattern, radiating ultraviolet (UV) light, and magnetically printing the servo pattern onto the polymer layer. The example method may also include forming a magnetic body by coating a magnetic body film on the servo pattern formed on the polymer layer, and etching a lower portion of a portion of the substrate of the magnetic printing stamp in a servo region.

According to another example embodiment, there is provided a magnetic printing method including aligning the magnetic printing stamp of claim 1 with a magnetic recording medium such that the magnetic printing stamp faces and comes in contact with the magnetic recording medium and printing a servo pattern on the magnetic recording medium by applying air pressure or oil pressure onto a back of the magnetic printing stamp and then applying an external magnetic field to the magnetic recording medium and the magnetic printing stamp.

### BRIEF DESCRIPTION OF THE DRAWINGS

Example embodiments will be more clearly understood from the following detailed description taken in conjunction with the accompanying drawings in which:

FIG. 1 is a diagram for explaining a structure of a magnetic recording medium;

FIG. 2 is a cross-sectional view of a magnetic printing stamp according to an example embodiment;

FIG. 3 is a cross-sectional view of a magnetic printing stamp according to another example embodiment;

FIG. 4 is a cross-sectional view of a magnetic printing stamp according to another example embodiment;

FIG. 5 is a manufacturing process chart for explaining a method of manufacturing a magnetic printing stamp of FIG. 2, according to an example embodiment;

FIG. 6 is a manufacturing process chart for explaining a method of manufacturing the magnetic printing stamp of FIG. 3, according to another example embodiment;

FIG. 7 is a manufacturing process chart for explaining a method of manufacturing the magnetic printing stamp of FIG. 4, according to another example embodiment;

FIG. 8 is a cross-sectional view of an apparatus for magnetically printing a servo pattern On a magnetic recording medium by using the magnetic printing stamp of FIG. 2, according to an example embodiment;

FIG. 9 is a cross-sectional view of an apparatus for magnetically printing a servo pattern on a magnetic recording medium by using the magnetic printing stamp of FIG. 3, according to an example embodiment; and

FIG. 10 is a cross-sectional view of an apparatus for magnetically printing a servo pattern on a magnetic recording medium by using the magnetic printing stamp of FIG. 4, according to an example embodiment;

### DETAILED DESCRIPTION OF THE EMBODIMENTS

Example embodiments will now be described more fully with reference to the accompanying drawings, in which example embodiments are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on”, “connected to”, or “coupled to” another element or layer, it can be directly on, connected to, or coupled to the other element or layer or intervening elements or layers that may be present. In contrast, when an element is referred to as being “directly on”, “directly connected to”, or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. Thus, a first element, component, region, layer, or section discussed below could be termed a second element, component, region, layer, or section without departing from the teachings of example embodiments.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configuration formed on the basis of manufacturing processes. Therefore, regions exemplified in figures have schematic properties and shapes of regions shown in figures exemplify specific shapes or regions of elements, and do not limit example embodiments.

Hereinafter, example embodiments will be described in detail by explaining the example embodiments with reference to the attached drawings. Like reference numerals in the drawings denote like elements.

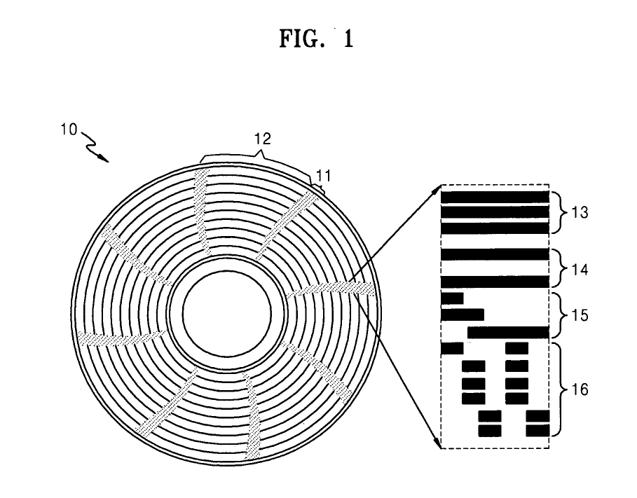

First, a structure of a magnetic recording medium will be described. FIG. 1 is a diagram for explaining a structure of a magnetic recording medium 10.

The magnetic recording medium 10 has a disc shape, wherein information may be recorded along a plurality of circular tracks. A region of the magnetic recording medium 10 is divided into a data sector 12, in which data may be recorded, and a servo sector 11, in which servo information may be recorded.

A servo pattern may be formed by magnetizing the servo sector 11 in a predetermined or desired pattern. For example, the servo pattern may include a preamble 13 providing servo synchronization, a servo address mark 14 signaling the beginning of the servo sector 11 to provide synchronization for reading a gray code 15 that may be next to the servo address mark 14, the gray code 15 providing a track identification, and a burst 16 providing information used to calculate a position error signal required to chase a track.

The shape of the servo pattern of FIG. 1 is for illustrative purposes only, and the shape may vary according to a track. When a hard disc drive (HDD) reproduces information recorded in the magnetic recording medium 10, the servo information is read from the servo pattern of the servo sector 11, and thus track searching and track following may be performed.

Example embodiments provide magnetic printing stamps having a structure in which a servo pattern may be recorded on a magnetic recording medium.

In example embodiments, a region of the magnetic printing stamp may be divided into a servo region having a servo pattern that is magnetized, and a data region occupying most of an area of the magnetic printing stamp and in which information recorded by a user is stored. The servo region may include patterned magnetic layers for magnetic printing of the servo pattern, which may be formed in the magnetic recording medium.

In the magnetic printing stamp, at least one of the group consisting of thickness and material of a substrate may differ between the data regions and the servo region of the magnetic recording medium. That is, the servo region may have a relatively uneven structure disposed thereon and may have a relatively small thickness compared to that of the data region. In addition, the material of the servo region may be the same as that of the data region, and may be relatively soft and relatively flexible.

In addition, when the servo pattern is to be magnetically printed, the magnetic printing stamp and a substrate of the magnetic recording medium are adjacent, aligned, and facing each other. Then, the magnetic printing stamp and the substrate of the magnetic recording medium come in contact with each other by applying air pressure or oil pressure onto the back of the magnetic printing stamp.

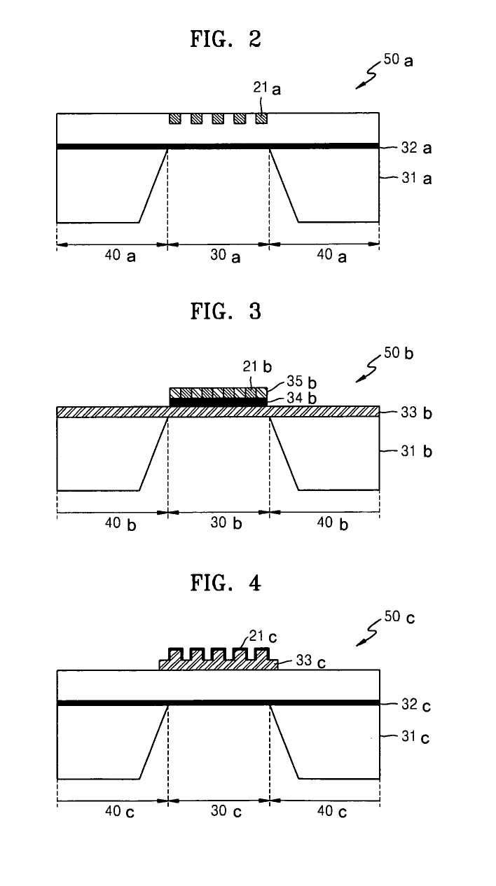

FIG. 2 is a cross-sectional view of a magnetic printing stamp 50a according to a first example embodiment of a magnetic printing stamp.

Referring to FIG. 2, a relatively uneven structure having a shape corresponding to a servo pattern is formed in a portion of a substrate 31a corresponding to a servo region 30a of the magnetic printing stamp 50a. In addition, a magnetic body 21a having a high saturation magnetic flux density Bs is embedded in grooves of the relatively uneven structure.

A groove is deeply formed in a back portion of the substrate 31a corresponding to the servo region 30a and thus a thickness of the substrate 31a in the servo region 30a is less than a thickness of the substrate 31a in a data region 40a. In order to control the depth of the groove formed in the back portion of the substrate 31a, a SiO₂ layer 32a may be formed in the substrate 31a of the magnetic printing stamp 50a.

FIG. 3 is a cross-sectional view of a magnetic printing stamp 50b according to a second example embodiment of a magnetic printing stamp.

Referring to FIG. 3, a portion of the substrate 31b corresponding to the servo region 30b of the magnetic printing stamp 50b is removed, and a first polymer layer 33b is formed above the substrate 31b. A seed metal layer 34b is formed on the first polymer layer 33b and a second polymer layer 35b is formed on the seed metal layer 34b, wherein a material for forming the second polymer layer 35b may be the same as or different from that of the first polymer layer 33b. A relatively uneven structure having a shape corresponding to a servo pattern is formed in the second polymer layer 35b.

Like FIG. 2, a magnetic body 21b having a high saturation magnetic flux density Bs is embedded in grooves of the relatively uneven structure. A groove is deeply formed in the back portion of the substrate 31b corresponding to the servo region 30b and thus a thickness of the substrate 31b in the servo region 30b is less than a thickness of the substrate 31b in the data region 40b.

FIG. 4 is a cross-sectional view of a magnetic printing stamp 50c according to a third example embodiment of a magnetic printing stamp.

Referring to FIG. 4, a groove is deeply formed in the back portion of the substrate 31c of the substrate 31c corresponding to the servo region 30c and thus a thickness of the substrate 31c in the servo region 30c is less than a thickness of the substrate 31c in the data region 40c. In order to determine the depth of the groove, the SiO₂ layer 32c may be formed in the substrate 31c of the magnetic printing stamp 50c. That is, most of a portion of the substrate 31c corresponding to the servo region 30c is removed and thus the portion of the substrate 31c corresponding to the servo region 30c remaining is relatively thin. In addition, a polymer layer 33c having an relatively uneven structure is formed on the substrate 31c. Unlike the example embodiment illustrated in FIG. 3, a seed metal layer is not formed, and the magnetic body 21c having a high saturation magnetic flux density Bs is continuously formed as a relatively thin film on the polymer layer 33c having the relatively uneven structure.

In FIGS. 2 through 4, the magnetic bodies 21a, 21b, and 21c may be formed of CoFe, CoNiFe, or the like, and may be a relatively soft magnetic body having a high saturation magnetic flux density Bs equal to or greater than about 1.5 T, and a coercive force equal to or less than about 100 Oe.

In FIGS. 2 through 4, the substrates 31a, 31b, and 31c of the example magnetic printing stamps 50a, 50b, and 50c may be formed of a hard material such as Si or glass, and may have a thickness in the range of several tens of millimeters to several hundred of millimeters.

In FIGS. 2 and 4, the portions of the substrates 31a, 31b, and 31c corresponding to the servo regions 30a, 30b, and 30c may have a thickness in the range of several millimeters to several tens of millimeters.

In FIG. 3, the first polymer layer 33b may have a thickness in the range of several millimeters to several tens of millimeters. The second polymer layer 35b may have a thickness in the range of several tens of millimeters to several hundred of millimeters.

In addition, in FIG. 4, the polymer layer 33c may have a thickness in the range of several millimeters to several tens of millimeters.

In FIGS. 2 through 4, a depth and a width of the uneven structures having a shape corresponding to the servo pattern may each be in the range of several millimeters to several hundreds of millimeters, and thus a thickness and a width of the magnetic bodies 21a, 21b, and 21c may each be in the range of several millimeters to several hundreds of millimeters.

In FIGS. 2 through 4, the shapes of the magnetic printing stamps 50a, 50b, and 50c according to the example embodiments are only examples for explaining a case where the portion of the substrates 31a, 31b, and 31c corresponding to the servo region 30a, 30b, and 30c may be relatively thin compared to the remaining portion, and the shape of the magnetic printing stamps 50a, 50b, and 50c may be variously changed.

For example, in FIGS. 2 through 4, a plurality of the servo regions 30a, 30b, and 30c may continuously be formed in a radial direction of the magnetic printing stamps 50a, 50b, and 50c having a disc shape, and may be spaced apart from one another in a circumferential direction of the magnetic printing stamps 50a, 50b, and 50c, and a portion of the substrates 31a, 31b, and 31c corresponding to each of the servo regions 30a, 30b, and 30c may be relatively slim. Alternatively, the servo regions 30a, 30b, and 30c may be spaced apart from one another in the radial direction as well as in the circumferential direction.

According to the example embodiments, portions of the magnetic printing stamps 50a, 50b, and 50c corresponding to the servo regions 30a, 30b, and 30c may be relatively thin, and may be formed of a relatively soft material. Thus, when the servo pattern is to be magnetically printed on the magnetic recording medium 10, the servo regions 30a, 30b, and 30c of the magnetic printing stamp 50a, 50b, and 50c may come in complete contact with the magnetic recording medium 10.

In addition, when the servo pattern is to be magnetically printed using any one of the magnetic printing stamps 50a, 50b, and 50c having this structure, the servo regions 30a, 30b, and 30c of the magnetic printing stamps 50a, 50b, and 50c, which may be relatively thin and relatively flexible, protrudes in a direction that is perpendicular to the substrates 31a, 31b, and 31c and the magnetic recording medium 10 by appropriately applying air pressure or oil pressure onto the magnetic printing stamps 50a, 50b, and 50c.

As a result, the data regions 40a, 40b, and 40c do not contact the magnetic recording medium 10, and thus the magnetic recording medium 10 and the magnetic printing stamps 50a, 50b, and 50c may be prevented from being damaged, thereby remarkably improving magnetic printing performance.

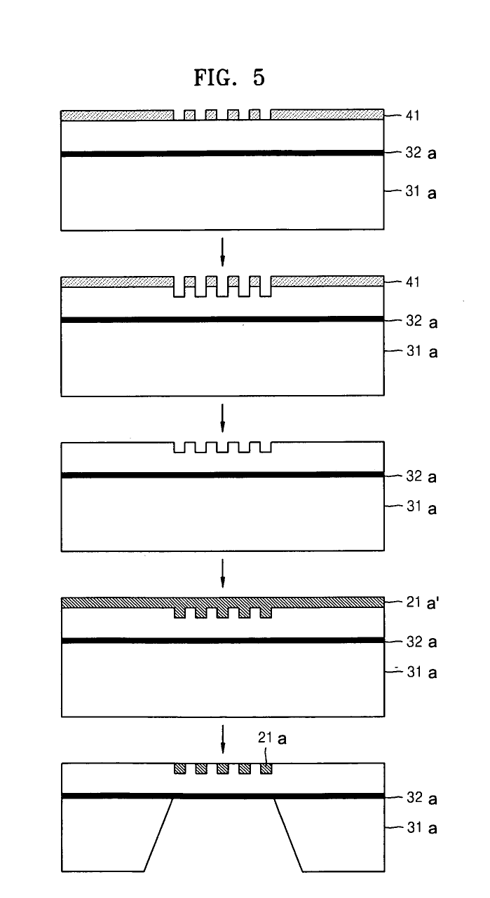

FIG. 5 is a manufacturing process chart for explaining a method of manufacturing the magnetic printing stamp 50a of FIG. 2, according to an example embodiment. The example method of manufacturing the magnetic printing stamp 50a of FIG. 2 will be described.

First, a electron beam resist 41 is coated on the substrate 31a of the magnetic printing stamp 50a. A servo pattern is patterned onto the electron beam resist 41. The servo pattern may be patterned onto the electron beam resist 41 by using a method such as electron beam lithography.

A portion of the substrate 31a corresponding to a servo region is etched to a predetermined or desired depth to have a shape corresponding to the shape of the patterned electron beam resist 41. The portion of the substrate 31a corresponding to the servo region may be dry-anisotropically etched to a predetermined or desired depth by using an etch mask, during which a reactive ion etching method may be used.

Then, the electron beam resist 41 is removed. The electron beam resist 41 may be removed via ashing, or the like. A magnetic body film 21a′ having a high saturation magnetic flux density Bs, such as CoFe or CoNiFe, is coated on the portion of the substrate 31a corresponding to the servo region, on which a servo pattern is formed, wherein grooves of the portion of the substrate 31a corresponding to a servo region are filled by the magnetic body film 21a′. Then, a magnetic body 21a corresponding to the servo pattern is formed. The magnetic body 21a may be formed, for example, by using a planarization method.

The portion of the substrate 31a corresponding to the servo region is thinner than a portion of the substrate 31a corresponding to a data region. The portion of the substrate 31a corresponding to the servo region may be thinned by patterning a lower portion of the portion of the substrate 31a corresponding to the servo region 30a of FIG. 2 by using a photolithography method, masking the lower portion by attaching a polyimide film onto the lower portion, and then putting a resulting structure into a KOH solution to perform wet anisotropic etch.

If a silicon on insulator (SOI) substrate is used as the substrate 31a, etching may be stopped at a buried oxide layer (for example, the SiO₂ layer 32a) and an etch depth may be easily controlled. The etched bottom surface may be planarized and uniformed. If the substrate 31a is a silicon (Si) substrate, an angle between a horizontal surface of the substrate 31a and an inclined surface of a wet etched groove may be about 65°.

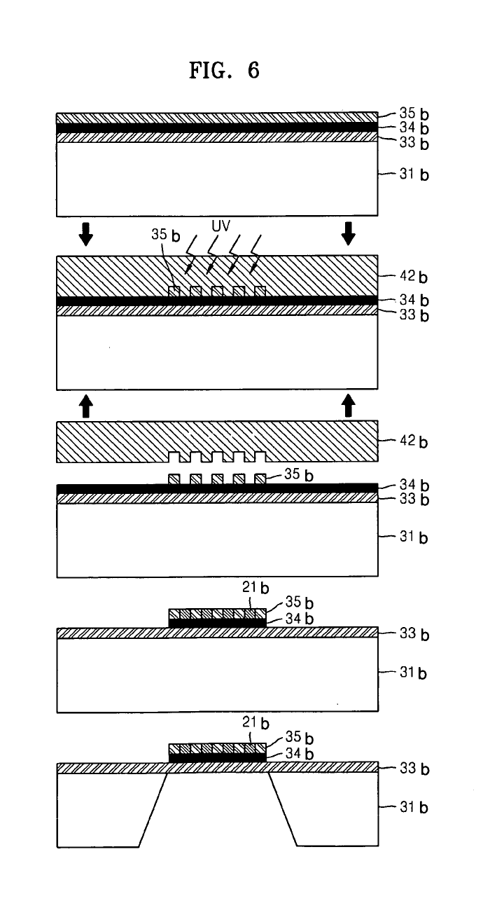

FIG. 6 is a manufacturing process chart for explaining a method of manufacturing the magnetic printing stamp 50b of FIG. 3, according to an example embodiment. The method of manufacturing the magnetic printing stamp 50b of FIG. 3 will be described.

A first ultra violet curable resin 33b (corresponding to the first polymer layer 33b of FIG. 3) is coated on the substrate 31b to a predetermined or desired thickness. The first ultra violet curable resin 33b may be coated on the substrate 31b to a predetermined or desired thickness by using a spin coating method.

Then, the seed metal layer 34b is formed on the first ultra violet curable resin 33b. The seed metal layer 34b may be formed on the first ultra violet curable resin 33b by using a sputtering method, a vacuum deposition method, or the like. The seed metal layer 34b may be formed of metal having excellent adherence with respect to the first ultra violet curable resin 33b.

A second ultraviolet curable resin 35b (corresponding to the second polymer layer 35b of FIG. 3) is coated on the seed metal layer 34b. The second ultraviolet curable resin 35b may be coated on the seed metal layer 34b by using a spin coating method, a dispensing method, or the like. A transparent stamp 42b having a servo pattern with a relatively uneven structure covers the second ultraviolet (UV) curable resin 35b, the servo pattern having the uneven structure is printed on the second UV curable resin 35b by using a nano imprinting method in which UV light is radiated, and then the transparent stamp 42b is removed.

When the nano imprinting method is used, a line-width of the uneven structure corresponding to the servo pattern may be finely achieved. In addition, since the nano imprinting method may use a master mold, repeat printing may be performed, and therefore mass production may be realized.

Then, a magnetic body corresponding to the servo pattern is formed by removing all but a portion of the seed metal layer 34 corresponding to the servo region (30b of FIG. 2) and then selectively growing a soft magnetic metal having a high saturation magnetic flux density Bs, such as CoFe or CoNiFe, on the remaining seed metal layer 34b. The seed metal layer 34b outside a region corresponding to the servo region (30b of FIG. 2) may be removed by using a photolithography method or a dry anisotropic etching method. The magnetic metal having a high saturation magnetic flux density Bs, such as CoFe or CoNiFe, may be grown on the seed metal layer 34 by using an electrolyte plating method.

Lastly, like in FIG. 5, the lower portion of the substrate 31b corresponding to the servo region may be removed. For example, the lower portion of the substrate 31b corresponding to the servo region (30b of FIG. 3) may be patterned using a photolithography method, the lower portion is masked by attaching a polyimide film onto the lower portion, and then a resulting structure is put into a KOH solution to perform wet anisotropic etch.

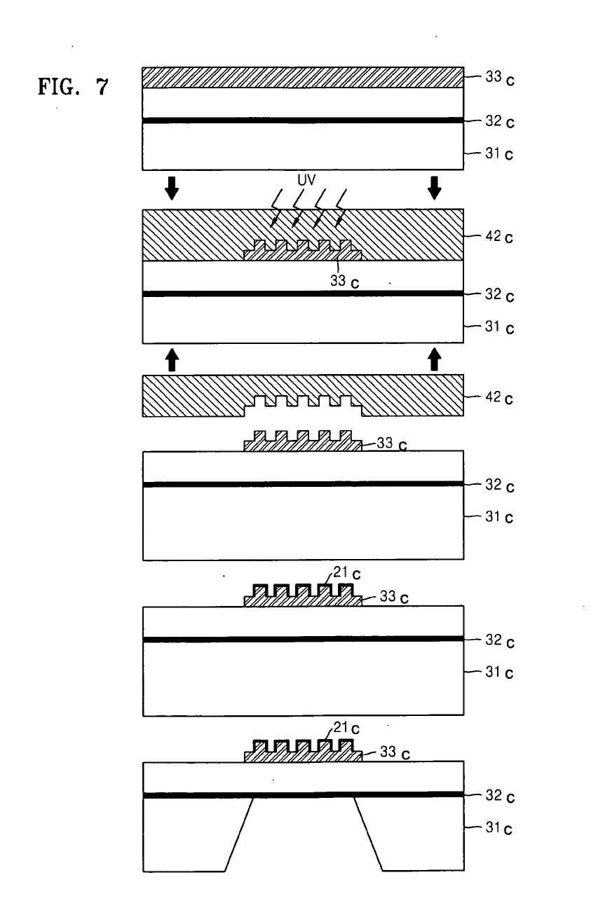

FIG. 7 is a manufacturing process chart for explaining a method of manufacturing the magnetic printing stamp 50c of FIG. 4, according to an example embodiment. The method of manufacturing the magnetic printing stamp 50c of FIG. 4 will be described.

A UV curable resin 33c (corresponding to the polymer layer 33c of FIG. 4) is coated on the substrate 31c to a predetermined or desired thickness. The UV curable resin 33c may be coated on the substrate 31c to a predetermined or desired thickness by using a spin coating method, a dispensing method, or the like.

As shown in FIG. 7, a transparent stamp 42c having a servo pattern with an uneven structure covers the UV curable resin 33c coated on the substrate 31c. The servo pattern having the uneven structure is printed on the UV curable resin 33c using a nano imprinting method in which UV light is radiated, and then the transparent stamp 42c is removed.

The magnetic body 21c is then formed. The magnetic body 21c may be formed by coating a film having a high saturation magnetic flux density Bs, such as CoFe or CoNiFe, on the servo pattern having the uneven structure formed on the UV curable resin 33c.

Lastly, like in FIG. 5, a lower portion of the substrate 31c corresponding to the servo region may be thinned. For example, the lower portion of the substrate 31c corresponding to the servo region (30c of FIG. 4) may be patterned using a photolithography method, the lower portion is masked by attaching a polyimide film onto the lower portion, and then a resulting structure is put into a KOH solution to perform wet anisotropic etch.

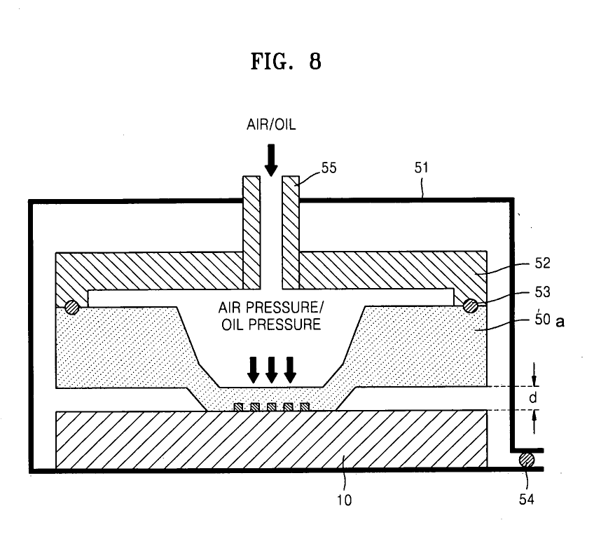

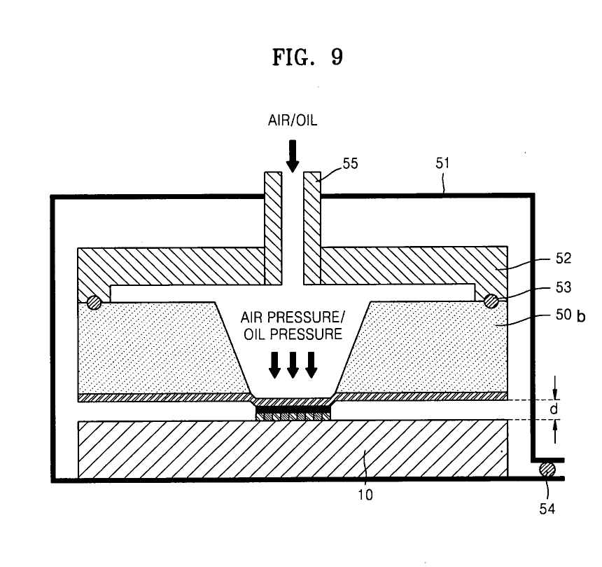

FIGS. 8, 9 and 10 are cross-sectional views of apparatuses for magnetically printing a servo pattern onto a magnetic recording medium by using the example magnetic printing stamps 50a, 50b, and 50c of FIGS. 2, 3 and 4, respectively, according to example embodiments.

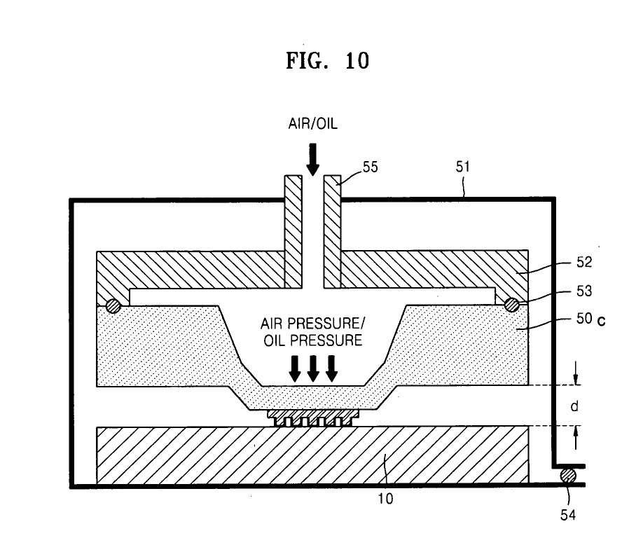

An oxide layer of a SiO substrate may be formed or not formed in each of the magnetic stamps 50a and 50c, but they are not shown in FIGS. 8 and 10 for simplicity.

Referring to FIGS. 8 through 10, the magnetic printing stamps 50a, 50b, and 50c are installed in a holder 52, and are aligned with and faces a substrate of the magnetic recording medium 10. Then, the magnetic printing stamps 50a, 50b, and 50c come in contact with the substrate of the magnetic recording medium 10.

At this time, the substrate of the magnetic recording medium 10 is initially magnetized in a predetermined or desired direction by applying an external magnetic field to the substrate of the magnetic recording medium 10. A sealant 53 is disposed between the magnetic printing stamps 50a, 50b, and 50c and the holder 52 so that the magnetic printing stamps 50a, 50b, and 50c and the holder 52 are sealed together, and so that air and oil may not leak.

Air pressure or oil pressure is applied to a servo region of the magnetic printing stamp 50 by generating a vacuum in a chamber 51 via a vacuum pump 54, and injecting air or oil into the holder 52 through an orifice 55 of the holder 52.

The chamber 51 is in a vacuum state, and an air pressure is applied into the holder 52. Thus, the servo regions 30a, 30b, and 30c of the magnetic printing stamps 50a, 50b, and 50c that are relatively thin and relatively flexible protrude in a direction perpendicular to the substrate of the magnetic recording medium 10. As shown in FIGS. 8-10, the air pressure or oil pressure applied to the servo region may cause the servo region to deform (stretch) by a distance d towards the magnetic recording medium 10.

Thus, since a data region of the magnetic printing stamp 50 is spaced apart from the magnetic recording medium 10 by a predetermined or desired distance, a plurality of servo regions of the magnetic printing stamps 50a, 50b, and 50c may come in complete contact with the substrate of the magnetic recording medium 10.

At this time, when an external magnetic field is applied to an assembly including the holder 52, the magnetic printing stamps 50a, 50b, and 50c, and the substrate of the magnetic recording medium 10, wherein a magnetization direction of the external magnetic field is opposite to that of the initial external magnetic field applied to the magnetic recording medium 10, the magnetic bodies 21a, 21b, and 21c of the magnetic printing stamps 50a, 50b, and 50c are magnetized, and thus a servo pattern is magnetically printed onto the magnetic recording medium 10.

While the inventive concept has been particularly shown and described with reference to exemplary embodiments thereof, it will be understood that various changes in form and details may be made therein without departing from the spirit and scope of the following claims.

1. A magnetic printing stamp comprising:
a plurality of servo regions having a magnetic body pattern; and
a plurality of data regions having no magnetic body pattern,
wherein the plurality of servo regions and the plurality of data regions are alternately formed, and a thickness of a portion of a substrate corresponding to each of the servo regions is less than a thickness of a portion of the substrate corresponding to each of the data regions.

2. The magnetic printing stamp of claim 1, wherein a material forming the portion of the substrate corresponding to each of the servo regions is the same as or more flexible than a material forming the portion of the substrate corresponding to each of the data regions.

3. The magnetic printing stamp of claim 1, wherein
an uneven structure corresponding to a servo pattern is in the portion of the substrate corresponding to each of the servo regions, and a magnetic body is embedded in grooves of the uneven structure.

4. The magnetic printing stamp of claim 1, wherein each of the servo regions comprises:
a first polymer layer as the lowest layer of each of the servo regions;
a seed layer on the first polymer layer; and
a second polymer layer having an uneven structure on the seed layer; and
a magnetic body embedded in grooves of the uneven structure of the second polymer layer.

5. The magnetic printing stamp of claim 4, wherein the seed layer is a metal layer.

6. The magnetic printing stamp of claim 1, wherein each of the servo regions comprises:
a silicon substrate as the lowest layer of each of the servo regions; and
a polymer layer having an uneven structure on the silicon substrate; and
a magnetic body film is coated on a surface of the polymer layer.

7. The magnetic printing stamp of claim 1, wherein
the magnetic body includes one of CoFe and CoNiFe,
the magnetic body has a high saturation magnetic flux density equal to or greater than about 1.5 T, and
the magnetic body has a coercive force equal to or less than about 100 Oe.

8. A method of manufacturing a magnetic printing stamp, the method comprising:
forming a magnetic body on a substrate; and
etching a lower portion of the substrate under the magnetic body.

9. The method of claim 8, wherein
forming the magnetic body on the substrate comprises
coating a top surface of the substrate with an electron beam resist,
patterning a servo pattern onto the electron beam resist over a servo region of the substrate,
etching the top surface of the substrate in the servo region to form grooves having a shape corresponding to the servo pattern of the electron beam resist,
removing the electron beam resist,
filling the grooves with a magnetic material, and
planarizing the top surface of the substrate; and
etching the lower portion of the substrate under the magnetic body comprises etching a lower portion of the substrate in the servo region.

10. The method of claim 9, wherein filling the grooves with a magnetic material includes coating a magnetic body film on the top surface of the substrate.

11. The method of claim 9, wherein etching the top surface of the substrate forms grooves in the substrate having one of a predetermined and desired depth.

12. The method of claim 9, wherein the electron beam resist is removed by ashing.

13. The method of claim 10, wherein the magnetic body film includes one of CoFe or CoNiFe.

14. The method of claim 8, wherein
forming the magnetic body on the substrate comprises
coating a first polymer layer on the substrate so that first polymer layer has one of a predetermined and desired thickness,
depositing seed metal on the first polymer layer,
coating a second polymer layer on the seed metal,
covering the second polymer layer with a transparent stamp having an uneven structure corresponding to a servo pattern so that the uneven structure is over a servo region of the substrate,
radiating ultraviolet (UV) to cure the second polymer layer thus forming lines of cured resin on the substrate over the servo region,
removing the transparent stamp,
removing the seed metal except for a remaining seed metal portion over the servo region, and
growing a magnetic metal on the remaining seed metal portion, and
etching the lower portion of the substrate under the magnetic body comprises etching a lower portion of the substrate in the servo region.

15. The method of claim 14, wherein the magnetic metal is one of CoFe and CoNiFe.

16. The method of claim 14, wherein an electrolyte plating method is used to grow the magnetic metal on the remaining seed metal portion.

17. The method of claim 8, wherein
forming the magnetic body on the substrate comprises
coating a polymer layer on the substrate,
covering the polymer layer with a transparent stamp having an uneven structure corresponding to a servo pattern,
radiating ultraviolet (UV) light to form a servo pattern on the polymer layer,
removing the transparent stamp, and
coating a magnetic body film on the servo pattern formed on the polymer layer; and
etching the lower portion of the substrate under the magnetic body comprises etching a lower portion of the substrate in the servo region.

18. The method of claim 17, wherein the magnetic body film includes one of CoFe and CoNiFe.

19. A magnetic printing method comprising:
aligning the magnetic printing stamp of claim 1 with a magnetic recording medium such that the magnetic printing stamp faces and comes in contact with the magnetic recording medium; and
printing a servo pattern on the magnetic recording medium by applying one of air pressure and oil pressure onto a back of the magnetic printing stamp and applying an external magnetic field to the magnetic recording medium and the magnetic printing stamp.

20. The method of claim 19, further comprising:
generating a vacuum in a chamber housing the magnetic recording medium.
